(19) United States
(12) Patent Application Publication
(10) Pub. No.: US 2010/0078494 A1
(43) Pub. Date: Apr. 1, 2010

(54) HUMIDITY-ACTIVATED VENTILATION SYSTEM SWITCH

(76) Inventors: Marco MULARONI, Phoenix, AZ (US); Robert A. SHERWOOD, EL Paso, TX (US)

Correspondence Address: YOUNG & THOMPSON, 209 Madison Street, Suite 500, Alexandria, VA, 22314, US

(21) Appl. No.: 12/243,456

(22) Filed: Oct. 1, 2008

(51) Int. Cl. F24F 3/14; G05D 22/00; F24F 7/007

(52) U.S. Cl. 236/44 A; 236/46 R; 236/49.3

(57) ABSTRACT

A humidity-activated switch comprising a humidity sensor and a microcontroller, wherein the switch may be automatically activated and/or deactivated in response to detected ambient humidity.

### FIELD OF THE INVENTION

The present invention relates to a humidity-activated switch, e.g., for automated control of a ventilation system.

### BACKGROUND OF THE INVENTION

Rooms, storage containers and other enclosures can suffer a variety of problems when exposed to humid conditions for extended periods of time. For example, humid air and the resulting moisture can promote growth of mold, bacteria, fungi, dust mites and other biological contaminants. These contaminants can pose serious health hazards to persons entering or occupying the affected area.

Humid conditions also can cause significant damage to building materials and property. For example, moisture resulting from humid air can damage paint and wallpaper, degrade building materials, and promote rust or decay of fixtures. Articles and equipment that are contained within a humid environment, such as computers and other electronics, machinery, artwork, furniture and the like, may be subject to damage or decay due to exposure to moisture contained in or condensed from humid air.

Ventilation systems, such as an exhaust fan, can be used to remove humid air from a room or other enclosure. However, such ventilation systems typically require manual operation to turn the system on and off. In that case, the ventilation system has no effect on humid conditions unless and until it is manually turned on by an individual operator. Conversely, once the system is turned on, it operates continuously even after the humid condition has been resolved until an individual manually turns it off. As a result, a manually operated ventilation system provides inadequate humidity control and wastes energy.

Automated ventilation systems have attempted to address the foregoing problems associated with manual systems. U.S. Pat. No. 6,935,570 describes a ventilation system in which a fan is activated when a gradient, or rate of change, of humidity at a given time exceeds by a given amount a previously determined gradient. With this system, the fan is not activated until after a certain rate of change in humidity is determined, at which time the humid condition may have already existed for some time. The delay involved with a gradient measurement may not allow the control system to react quickly enough. Also, a gradient-based control could fail to activate when the humidity increases at a slow rate over an extended period of time, such that excessive humidity could result and remain uncontrolled. Moreover, the electronics required for determination and comparison of two separate gradient values is relatively complex, which increases size and cost.

U.S. Pat. No. 6,230,980 describes a method in which an exhaust fan is activated when a measured humidity value exceeds a previously calculated value, where the previously calculated value is an average humidity value over some period of time. This method requires complicated, and thus costly, circuitry and memory storage that continuously monitor and store ambient humidity values, average those values over a fixed period of time to obtain an averaged value, and periodically replace the stored averaged value with a new averaged value calculated as the average of yet another set of ambient humidity values measured over time. In addition to requiring complex and costly circuitry, the calculation of an averaged humidity value over time delays the availability of a current reference, resulting in inadequate response to potentially harmful humidity conditions. Also, an averaged humidity would be subject to artificially high or low points during the averaging period and, thus, may not accurately represent a current reference.

### SUMMARY OF THE INVENTION

The present invention relates to a humidity-activated switch which self-activates when a measured ambient humidity value exceeds a regularly updated reference value by a given amount. The humidity-activated switch of the present invention may be used, e.g., to operate a ventilation system, such as an exhaust fan, in order to prevent excessive humidity in a room or other enclosure.

The humidity-activated switch includes a humidity sensor for determining ambient humidity values and a microcontroller which is operatively connected to the humidity sensor.

The humidity sensor is used to determine the current ambient humidity in the room or enclosure. Any sensor which is capable of detecting and responding to ambient humidity may be used. The humidity sensor is preferably an electronic humidity sensor which provides an electrical response with changes in ambient humidity. Preferably, the electronic humidity sensor responds to changes in relative humidity (RH). Electronic sensors, including electronic RH sensors, are readily available on the market and provide a cost effective and reliable solution for this application.

RH sensors may inherently be influenced by temperature. However, in this application expected temperature changes are typically small enough to make any temperature influence insignificant. Alternatively, the humidity sensor can include a mechanism for temperature compensation, particularly where significant temperature changes might be anticipated. Any known temperature compensation circuitry or other mechanism can be used.

The humidity sensor can be co-located with the microcontroller or alternatively can be remote from the microcontroller. The humidity sensor and microcontroller can be connected via hard wiring, wireless connection or any other known mechanism capable of operatively connecting these components

A current ambient humidity value is communicated from the humidity sensor to a microcontroller unit (MCU) and supporting electronics, such as an integrated circuit board. Preferably, the humidity sensor is configured in an oscillator circuit whose frequency, preferably approximately 100 kHz at 50% RH, is determined by ambient relative humidity. In a preferred embodiment, this oscillator circuit drives the clock signal of the MCU. The time taken for the MCU to execute an instruction is therefore determined by ambient humidity.

The MCU also may be configured to receive A/C line signal transitions. In this preferred embodiment, the MCU starts an instruction count on the first positive transition. A fixed number, preferably approximately 20, of AC line positive transitions later, the value of the instruction counter is examined. The humidity sensor oscillator frequency is calculated using the number of MCU instructions counted and the fixed time period of positive A/C transitions. The actual humidity value is then determined via an algorithm which correlates the oscillator frequency to humidity. This alleviates the need to configure the MCU with a crystal oscillator since the A/C signal provides a very accurate time reference resulting in reduced cost.

The MCU receives and processes the ambient humidity value to determine whether a qualifying humidity event has occurred.

A qualifying humidity event can occur, for example, when the current humidity differs from a stored baseline humidity value by a preset amount. For example, operating a shower in a commercial or residential bathroom may create a humidity event. In a preferred embodiment, the MCU uses an algorithm to determine whether a qualifying humidity event has occurred.

The MCU can be operatively associated with a ventilation system, preferably via a switch circuit.

If a qualifying humidity event has occurred, the MCU will then either activate or deactivate the ventilation system.

Preferably, the MCU sends a signal, responsive to the detection of a qualifying humidity event, to the switch circuit, which then turns the ventilation system, or a component of the ventilation system, on or off.

The switch circuit can be designed appropriately to drive the ventilation system in any known manner, including via an electronic or electro-mechanical components, wiring or wireless communication. The Switch type and its connection to a ventilation system may be customized to a given application, taking into account the type and location of enclosure, the relative ease of installation (e.g., retrofit vs. new installation), cost, and local codes.

The MCU itself preferably supports a coded algorithm stored in memory. However, it also is contemplated to use an assembly of discrete integrated circuits to support equivalent functionality.

In a preferred embodiment, the electronics that make up the humidity switch are housed within a housing that is dimensionally similar to a standard electrical wall-mounted light switch. In this embodiment, the humidity switch can be applied as a retrofit to existing residential or commercial ventilation fan switches as well as new installations.

In another preferred embodiment, the electronics also support a manual mode that enables a user to selectively activate and/or deactivate the ventilation fan. In this embodiment, the manual mode operates as a timed switch to save energy. For example, when manual mode operation is used to activate a ventilation system, that ventilation system is automatically deactivated after a preset time. In addition, the manual mode operation preferably is disabled when the device is operating in an automatic mode. This ensures that the ventilation system is not prematurely deactivated and has adequate time to remove humidity from the enclosure.

The electronics housing can also include an indicator light, e.g. an LED indicator, which illuminates when the ventilation system is activated and turns off when the ventilation system is deactivated. In addition, the electronics housing can also include other features such as an occupancy sensor, which when coupled with light fixtures, wired or wirelessly, and/or a ventilation system, can add an additional level of functionality including energy savings and a higher level of automation based on whether the user is in the room/enclosure. For example, an occupancy sensor, which may be any known device capable of detecting the presence of an individual, such as infrared sensors, may be included to control lighting. Additionally, the occupancy sensor may be configured to optionally prevent automated operation of the switch in the event of a humidity event when no individual is present in the enclosure. This preferred embodiment can be useful where it is desired to limit the automated switch activation to humidity events arising due to human activity, e.g., operating a shower in a commercial or residential bathroom.

The stored baseline humidity value is replaced with a new baseline value according to a predefined schedule. Preferably, in the absence of a humidity qualifying event, the current ambient humidity is periodically stored as the current baseline value. The stored baseline value also can be replaced by a measured current ambient humidity following the conclusion of a humidity qualifying event, such as deactivation of a ventilation system. Preferably, the stored baseline value also is updated after manual deactivation when operating in manual mode.

### BRIEF DESCRIPTION OF THE DRAWINGS

FIG. 1 depicts a preferred embodiment of the invention.

FIG. 2 depicts a block diagram of the electronics in a preferred embodiment of the invention.

FIG. 3 depicts an operational flow chart of a preferred embodiment of the invention.

### DESCRIPTION OF THE PREFERRED EMBODIMENTS

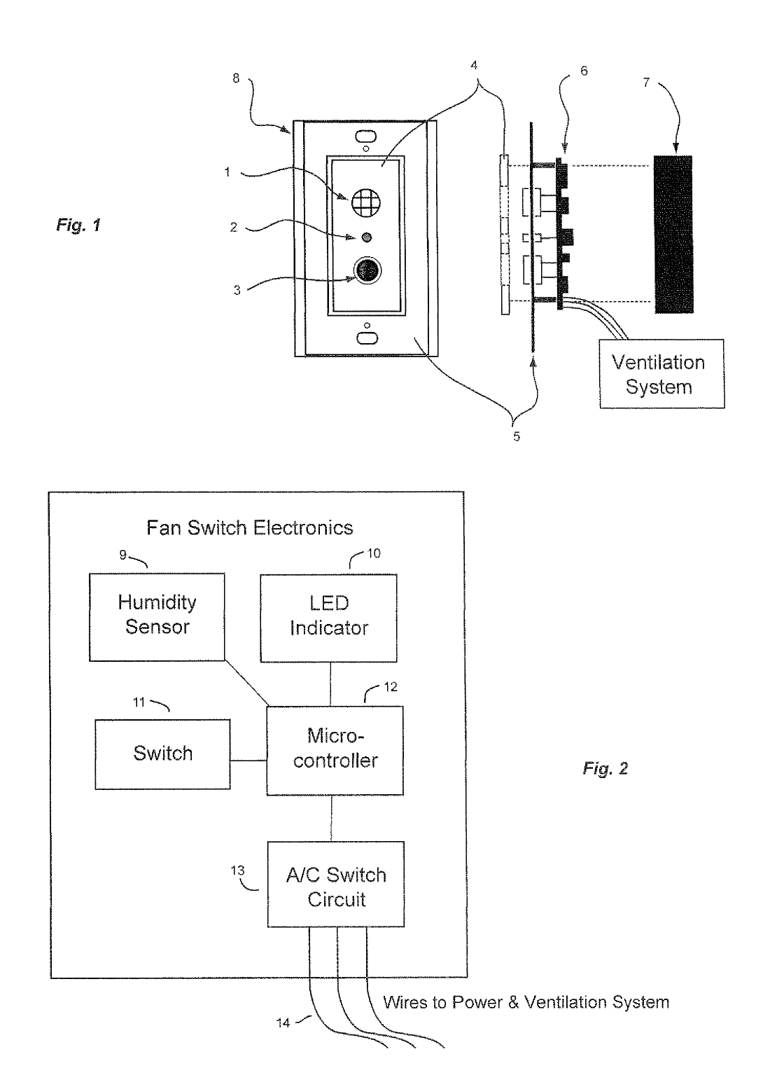

FIG. 1 depicts a switch assembly according to a preferred embodiment of the invention which includes a humidity sensor (1), LED indicator (2), and a manual switch such as a pushbutton switch (3). The manual switch preferably protrudes through plastic switch cover (4). Plastic switch cover (4), an electronics board (6), and an electronics cover (7) all mount to a metal switch mounting bracket (5). A Fan switch assembly is mounted in an electrical box (8).

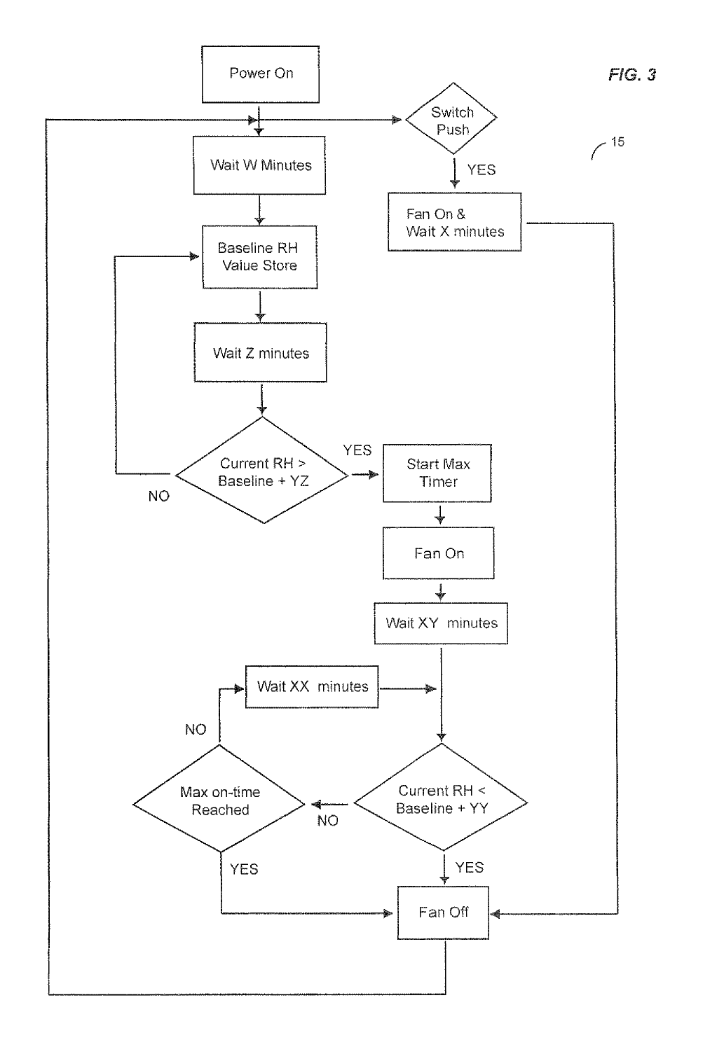

The switch electronics of a preferred embodiment are shown in FIG. 2. In that embodiment, humidity sensor (9) and switch (11) are read by microcontroller (12). Microcontroller (12) stores a baseline value received from humidity sensor (9), and stores predetermined on/off threshold values relative to the stored baseline value. The ambient and threshold values are compared by microcontroller (12). Responsive to the comparison performed by the microcontroller, A/C switch circuit (13) is activated or deactivated according to a control algorithm (15) (shown in FIG. 3).

FIG. 3 shows a preferred control algorithm. Upon installation and powering of the humidity switch, the algorithm in FIG. 3 starts. A waiting period W is executed allowing the ambient humidity to settle after the initial power-on. Any period of time may be selected for W, which may or may not be based upon the particular setting and ambient conditions, although 1-5 minutes is preferred.

Following the waiting period W the current ambient relative humidity is stored as the current baseline in memory. This begins the main algorithmic loop. After the baseline RH value is stored, a waiting period Z occurs. Any period of time may be selected for Z, although 1-5 minutes is preferred.

Waiting period Z is followed by a comparison of the current ambient RH and the sum of the baseline humidity value and a predefined constant YZ. Any value may be assigned to constant YZ, although preferably YZ is 5-10% relative humidity. If the current ambient humidity is less than the sum of the baseline value and constant YZ, the current humidity is stored as a new baseline value and waiting period Z is recommenced.

If the current ambient humidity is not less than the sum of the baseline value and constant YZ, a predefined timer (“max timer”) is started and the fan is activated. The max timer can be set for any period of time that is selected as a maximum time of fan operation, preferably 30 minutes or longer. Upon activation of the fan, a waiting period, XY, is initiated.

The period XY can be any desired length of time, and preferably is at least 15 minutes.

At the conclusion of period XY, the current ambient RH is compared with the sum of the stored baseline humidity value and a predefined constant YY. Any value may be assigned to constant YY, although preferably YY is 3-5% relative humidity.

If the current ambient humidity is less than the sum of the baseline value and constant YY, or if the period of time assigned to the max timer has expired, then the fan is deactivated and the algorithm returns to the initiation of waiting period W, as described above. If neither of those conditions is present, then a waiting period XX is initiated.

At the conclusion of waiting period XX, the current ambient RH is compared with the sum of the stored baseline humidity value and a predefined constant YY in the same manner as described above. Waiting period XX can be any value, including zero, the same value as XY, or any other desired value of time.

Preferably, XX is equal to or less than XY.

Optionally, the algorithm also includes provision for a manual mode operation of the fan. In this preferred embodiment, before initiating the waiting period W, the algorithm determines whether a manual fan activation switch has been toggled on. If toggled on, then the fan is activated. At the conclusion of a predefined period of time X, unless the fan has been manually deactivated by operation of the manual switch, the fan is automatically deactivated. Any period of time may be selected for X, although 15 minutes or more is preferred. In either case, whether the fan is manually or automatically deactivated, the algorithm then returns to the initiation of waiting period W, as described above. Preferably, the manual switch is rendered inoperable for deactivating the fan when the fan has been activated automatically.

Although various preferred embodiments are illustrated and described herein, it will be appreciated by persons of ordinary skill in the art that modifications and variations of the present invention are possible in light of the above disclosure, and such modifications and variations are considered within the purview of the appended claims without departing from the spirit and intended scope of the claimed invention.

What is claimed is:

1. A humidity-activated switch comprising:
a humidity sensor capable of detecting a current ambient humidity value;
a microcontroller operatively connected to said humidity sensor and configured so as to receive said current ambient humidity value detected by said humidity sensor; and
a connection for connecting said microcontroller to a power source;
wherein said microcontroller is configured so as to: store a baseline humidity value; receive said current humidity value from said humidity sensor; compare said current humidity value with said stored baseline humidity value; and periodically replace said stored baseline humidity value with said current ambient humidity value detected by said humidity sensor; and
wherein said switch is configured so as to be automatically activated if said current ambient humidity value exceeds said stored baseline humidity value by a predefined amount.

2. The humidity-activated switch as claimed in claim 1, wherein said microcontroller is configured so as to periodically receive said current ambient humidity value, when said switch has not been automatically activated, following a recurring waiting period.

3. The humidity-activated switch as claimed in claim 2, wherein said recurring waiting period is from about one to about five minutes.

4. The humidity-activated switch as claimed in claim 2, wherein said microcontroller is configured to replace said stored baseline humidity value with each periodically received current ambient humidity value if said current humidity value does not exceed said stored baseline value by said predefined amount.

5. The humidity-activated switch as claimed in claim 1, wherein said predefined amount is from about 5 to about 10 percent relative humidity.

6. The humidity-activated switch as claimed in claim 1, wherein said microcontroller is configured so as to periodically receive said current ambient humidity value, when said switch has been automatically activated, following a recurring waiting period.

7. The humidity-activated switch as claimed in claim 6, wherein said recurring waiting period is at least about fifteen minutes.

8. The humidity-activated switch as claimed in claim 6, wherein said switch is configured so as to be automatically deactivated if said current ambient humidity value is less than a predefined value.

9. The humidity-activated switch as claimed in claim 8, wherein said predefined value is said stored baseline humidity value plus about three to about five percent relative humidity.

10. The humidity-activated switch as claimed in claim 1, further including a timer operatively associated with said microcontroller, wherein said timer is configured to operate for a preset time when said switch is automatically activated.

11. The humidity-activated switch as claimed in claim 10, wherein said switch is configured to be automatically deactivated at the conclusion of said preset time.

12. The humidity-activated switch as claimed in claim 11, wherein said preset time is at least about thirty minutes.

13. The humidity-activated switch as claimed in claim 1, wherein said switch is operatively connected to a ventilation system.

14. The humidity-activated switch as claimed in claim 13, wherein said ventilation system includes a fan, wherein said fan is configured to be activated when said switch is activated.

15. The humidity-activated switch as claimed in claim 1, further comprising a manually operated mechanism which is capable of selectively activating and deactivating said switch.

16. The humidity-activated switch as claimed in claim 15, wherein said manually operated mechanism is disabled when said switch is automatically activated.

17. The humidity-activated switch as claimed in claim 1, wherein said microcontroller is configured so as to replace said stored baseline humidity value with said current ambient humidity value after said switch is deactivated.

18. The humidity-activated switch as claimed in claim 1, wherein said microcontroller is included in an integrated circuit board.

19. A humidity-activated switch comprising:
a humidity sensor capable of detecting a current ambient humidity value;
a microcontroller operatively connected to said humidity sensor and configured so as to receive said current ambient humidity value detected by said humidity sensor; and
a connection for connecting said microcontroller to a power source;
wherein said microcontroller is configured so as to:
store a baseline humidity value;
periodically receive said current ambient humidity value following a first recurring waiting period;
replace said stored baseline humidity value with each periodically received current ambient humidity value if said current humidity value does not exceed said stored baseline value by a predefined amount;
automatically activate said switch if said current ambient humidity value exceeds said stored baseline value by said predefined amount;
periodically receive said current ambient humidity value, when said switch has been automatically activated, following a recurring second waiting period;
automatically deactivate said switch, when said switch has been automatically activated, if said current ambient humidity value is less than a predefined value; and
replace said stored baseline humidity value with said current ambient humidity value after said switch is deactivated.

20. The humidity-activated switch as claimed in claim 19, further comprising a manually operated mechanism which is capable of selectively activating and deactivating said switch, wherein said manually operated mechanism is disabled when said switch is automatically activated.

21. The humidity-activated switch as claimed in claim 1, including an oscillator whose frequency is determined by ambient humidity, wherein said microcontroller is configured to receive its clock signal from said oscillator.

22. The humidity-activated switch in claim 21, wherein the instruction execution time of said microcontroller is determined by said oscillator.

23. The humidity-activated switch in claim 22, wherein said microcontroller is further configured to receive signal transitions from an A/C power line signal and to count microcontroller instructions upon receiving the first positive A/C power line transition and continuing for a fixed number of positive transitions.

24. The humidity-activated switch in claim 23, wherein said microcontroller is further configured to calculate the frequency of said oscillator based on the length of time the instruction counter is active and the number of instructions counted.

25. The humidity-activated switch in claim 24, wherein said microcontroller is further configured to determine the current ambient humidity value from the calculated oscillator frequency via an algorithm.

26. A method comprising:
providing an oscillator circuit having a frequency which is determined by ambient humidity;
providing a microcontroller unit operatively connected to said oscillator circuit;
driving a clock signal of said microcontroller unit by said oscillator circuit, wherein said microcontroller processes instructions at a speed governed by said clock signal;
providing an A/C line signal to said microcontroller unit, said A/C line signal including signal transitions;
counting the number of microcontroller instructions occurring over a fixed number of signal transitions;
calculating said frequency of said oscillator circuit based on the counted number of microcontroller instructions; and
determining ambient humidity based on said calculated frequency.

27. A method as claimed in claim 26, further comprising activating a switch in response to said determined ambient humidity.
